(19) United States
(12) Patent Application Publication
(10) Pub. No.: US 2023/0263343 A1
(43) Pub. Date: Aug. 24, 2023

(54) PUMP ASSEMBLY AND LIQUID DISPENSING DEVICE

(71) Applicant: CONOPCO, INC., D/B/A UNILEVER, Englewood Cliffs, NJ (US)

(72) Inventors: Jun SHEN, Shanghai (CN); Keke FENG, Shanghai (CN); Lixiao ZHANG, Shanghai (CN)

(73) Assignee: CONOPCO, INC., D/B/A UNILEVER, Englewood Cliffs, NJ (US)

(21) Appl. No.: 18/005,613

(22) PCT Filed: Jul. 22, 2021
(86) PCT No.: PCT/EP2021/070509

§ 371 Date: Jan. 16, 2023

(30) Foreign Application Priority Data
Aug. 12, 2020 (WO) PCT/CN2020/108725
Sep. 18, 2020 (EP) 20196867.4

(51) Int. Cl. A47K 5/16; B05B 12/12; B05B 7/00

(52) U.S. Cl. CPC A47K 5/16; B05B 12/124; B05B 7/0037

(57) ABSTRACT

Disclosed is an integrated pump assembly for a liquid dispensing device and a liquid dispensing device thereof. The pump assembly for the liquid dispensing device comprises a flow path board formed with a flow path therein to receive liquid from a liquid source and dispense a gas-liquid mixture, a gas-liquid mixing pump connected with the flow path board to receive the liquid therefrom and return the gas-liquid mixture thereto, and a main control board for controlling the operation of the gas-liquid mixing pump, wherein the flow path board comprises an upper board and a lower board fitted to each other with the flow path formed therebetween. The liquid dispensing device comprises a housing, said pump assembly configured to be accommodated in said housing and a power supply to supply power to said pump assembly.

### FIELD OF THE INVENTION

The present invention is related to a pump assembly for a liquid dispensing device and a liquid dispensing device thereof.

### BACKGROUND OF THE INVENTION

Liquid dispensing device is widely used now at home or in public areas such as restaurants, airports, public restrooms to provide cleansing liquid like hand sanitizers. Automatic liquid dispensing device has also been developed recently and used where a hand-free operation is needed.

The liquid dispensing device on market generally adopts a complicated structure comprising many separate components such as a motor, a bulky gas-liquid transferring assembly, a control board and a sensor, etc. Additionally, the motor usually cannot be mounted quickly and firmly onto the gas-liquid transferring assembly, which makes assembling and maintenance of the device quite complicated and time-consuming. Furthermore, the gas-liquid transferring assembly usually adopts silicone hoses to transfer liquid and gas separately which may incur accidental leakage. In addition, the foam boosters of the existing device are made of stainless steel subject to high risk of corrosion which may result in product failure.

CN 111657773 A discloses an automatic liquid feeding machine. The automatic liquid feeding machine comprises a pump assembly, a liquid storage bottle, an inductive probe, a control panel and a liquid outlet nozzle, a liquid inlet of the pump assembly is used for pumping liquid in the liquid storage bottle, the pump assembly and the inductive probe are electrically connected with the control panel, the liquid outlet nozzle comprises a liquid outlet nozzle shell, the liquid outlet nozzle shell is provided with a liquid inlet and a liquid outlet, the liquid inlet of the liquid outlet nozzle shell is communicated with the liquid outlet of the pump assembly, the inductive probe is arranged in the liquid outlet nozzle shell, a probe shell of the inductive probe and the liquid outlet nozzle shell jointly define a liquid outlet channel, and the liquid outlet channel is communicated with the liquid inlet and the liquid outlet nozzle shell.

Therefore, the present inventors have recognized that there is a need to develop a liquid dispensing device with a much simpler and more durable structure which is easier to assemble and repair, and also has a prolonged lifetime.

### SUMMARY OF THE INVENTION

In a first aspect, the present invention is directed to an integrated pump assembly for a liquid dispensing device comprising a flow path board formed with a flow path therein to receive liquid from a liquid source and dispense a gas-liquid mixture; a gas-liquid mixing pump connected with the flow path board to receive the liquid therefrom and return the gas-liquid mixture thereto; and a main control board for controlling the operation of the gas-liquid mixing pump, wherein the flow path board comprises an upper board and a lower board fitted to each other with the flow path formed therebetween.

In a second aspect, the present invention is directed to a liquid dispensing device comprising a housing, a pump assembly of any embodiment of the first aspect of this invention configured to be accommodated in the housing, and a power supply to supply power to the pump assembly.

These and other aspects of the present invention will more readily become apparent upon considering the detailed description and examples which follow.

### BRIEF DESCRIPTION OF THE FIGURES

FIG. 1 is an exploded perspective view of a preferred embodiment of the liquid dispensing device according to the present invention.

FIG. 2 is an exploded perspective view of a preferred embodiment of the pump assembly and tube for the liquid dispensing device as shown in FIG. 1.

FIGS. 3a and 3b are exploded perspective views of the flow path board of the pump assembly and tube as shown in FIG. 2 as seen from below and above respectively.

FIG. 4 is a bottom view of the upper board of the flow path board as shown in FIGS. 3a and 3b.

FIGS. 5 is a bottom view of the lower board of the flow path board as shown in FIGS. 3a and 3b.

FIG. 6 is a schematic sectional view of the flow path board, the pump, and tube in an assembled state, with an interior of the pump omitted.

### DESCRIPTION OF THE SYMBOLS

### 1. Housing

2. Pump assembly
3. Power supply
4. Main body

### 5. Projection

### 6. Nozzle

### 7. Cover

8. Upper opening

### 9. Shield

10. Battery cover
11. Side opening
12. Gas-liquid mixing pump
13. Flow path board
14. Main control board

### 15, 23, 27. Inlet

### 16, 24. Outlet

17. Upper board
18. Lower board

### 19. Chamber

20. Partition wall
21. Pre-mixing region
22. Mixed region

### 25. Tube

26. Sealing member
28. Buffer zone
29. Discharging zone

### 30. Barrier

### 31. Passage

32. Upper segment
33. Lower segment

### 34. Gap

### 35. Port

36. Foam booster

### 37. Cavity

### 38. Sensor

39. Inner wall

### 40. Flange

### 41. Hook

### 42. Protrusion

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

For the convenience of description, terms indicating directions such as “upper”, “lower”, “top”, “bottom”, “above”, “below”, “inner”, “outer”, “inward”, “outward”, “inside”, “outside” and the like are intended to explain relative positions among components of the device only, and should not be construed as limiting the scopes of the present invention.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a product of the invention), such disclosure is also to be considered to apply to any other aspect of the invention (for example a process of the invention) mutatis mutandis.

The present invention relates to an integrated pump assembly for a liquid dispensing device and a liquid dispensing device thereof.

Preferably, the liquid dispensing device comprising a housing; a pump assembly configured to be accommodated in the housing; and a power supply to supply power to the pump assembly.

The integrated pump assembly according to the present invention comprises a flow path board formed with a flow path therein to receive liquid from a liquid source and dispense a gas-liquid mixture, a gas-liquid mixing pump connected with the flow path board to receive the liquid therefrom and return the gas-liquid mixture thereto, and a main control board for controlling the operation of the gas-liquid mixing pump. “Integrated” as used herein means that the flow path board, the gas-liquid mixing pump, and the main control board are incorporated together as a whole.

To make the pump assembly be detached from the housing quickly and easily, the pump assembly is formed into one independent module. Preferably, the pump assembly is fixed in position by press fitted into the housing. Thereby no dedicated fixing means for the pump assembly is needed, which reduces the number of components of the device.

Preferably, the flow path board is provided with a pre-mixing region and a mixed region located at an upstream and a downstream of the gas-liquid mixing pump respectively. The pre-mixing region and the mixed region are preferably separated from each other fluid-tightly. For example, the pre-mixing region is configured to be in fluid communication with the liquid source and an inlet of the gas-liquid mixing pump, and the mixed region is in fluid communication with an outlet of the gas-liquid mixing pump and a nozzle of the device.

Preferably, the mixed region is provided with a buffer zone and a discharging zone communicated with each other. Preferably, a barrier is located between an inlet of the flow path board, which is fitted with the outlet of the gas-liquid mixing pump, and the nozzle. It is preferable that a passage is formed between an end, preferably an upper end, of the barrier and an inner wall surface of the flow path board. Alternatively, the passage is an opening penetrating the barrier itself.

Preferably, the flow path board comprises an upper board and a lower board fitted to each other with the flow path formed therebetween. Preferably a tube is arranged at the flow path board to communicate with the liquid source. Preferably, the tube is arranged perpendicular to the upper board and the lower board. Preferably, the tube is arranged parallelly to and side-by-side with the gas-liquid mixing pump to save the space. Preferably, the maximum dimension of the tube and that of the gas-liquid mixing pump is substantially the same. Preferably the tube is made of a rigid plastic. The tube may be formed with the flow path board integrally. Alternatively, the tube is inserted into the flow path board as an individual member. The tube may be press fitted into the flow path board so that no additional sealing member is necessary. Alternatively, a sealing member such as an O-ring is arranged between the tube and the flow path board. Preferably, the flow path board is formed by injection moulding.

The lower board may be provided with an inlet and an outlet to be connected with the gas-liquid mixing pump. The lower board may be press fitted to the pump without any additional sealing member therebetween. Alternatively, it is fitted to the pump via a sealing member.

Preferably, a gas-liquid mixture coming out of the gas-liquid mixing pump is in the form of foam. It is preferable that a foam booster is provided in the flow path board to boost foam. Preferably the foam booster has a porous structure. The foam booster is preferably located at a nozzle of the flow path board and/or in a passage located at a side of the nozzle. The foam booster may be provided in the passage in the mixed region, e.g., between the buffer zone and the discharging zone. The foam booster may be formed by the barrier itself, (e.g., by perforated holes formed in the barrier) or be provided as a separate member.

Preferably, the passage is provided with a port which directs the gas-liquid mixture into the discharging zone. Thus, disturbance of the gas-liquid mixture near the nozzle is reduced and the gas-liquid mixture may be dispensed in a more stable and smoother way.

The foam booster is preferably made of plastic instead of conventional stainless steel to reduce the risk of liquid corrosion which may result in product failure. Nylon is particularly preferred. It is preferable that the foam booster comprises one or more of plastic layers, more preferably two plastic layers, most preferably two nylon layers.

The main control board is preferably configured as PCB (Printed Circuit Board). Preferably, the main control board has a sensor mounted thereon, and the sensor is inserted into the flow path board for sensing approaching of an object. The sensor is preferably a contactless distance sensor, more preferably an infrared sensor.

Preferably, the liquid dispensing device is configured to be activated by the sensor automatically. The liquid dispensing device may also be activated manually, e.g. by pressing a button, turning on a switch, or the like.

Preferably, a separate cavity is formed in the flow path board to receive the sensor. The cavity may be spaced from opposite inner wall surfaces of the flow path board to establish bypass paths for the gas-liquid mixture to flow through to the nozzle which further prevents the disturbance of the gas-liquid mixture.

Preferably, the flow path board is snap-fitted to the gas-liquid mixing pump, and/or the main control board is snap-fitted to the flow path board. With such an assembling process, the pump assembly is assembled much quicker and easier.

Preferably, the gas-liquid mixing pump is connected with the flow path board directly without any conventional silicone hose connections, which greatly reduces the risk of leakage due to deteriorated sealing or aging of hoses therefore prolongs the lifetime of the device. Preferably the gas-liquid mixing pump is a peristaltic pump.

The housing of the liquid dispensing device of this invention comprises a main body to accommodate the pump assembly of the present invention. The main body is preferably elongate meaning that the longitudinal dimension of the main body is longer that the lateral dimension. The main body of the housing may be in any suitable shape, for example, polyhedron, cylinder, truncated cone, sphere shaped or in shape of animals. It is preferable that the main body is in shape of polyhedron, cylinder, or truncated cone, more preferably in shape of cylinder or truncated cone. Most preferably the main body of the housing is in shape of cylinder.

Preferably, the power supply to supply power to the pump assembly of the present invention is batteries, e.g., rechargeable batteries. The batteries are preferably accessible from a lateral side of the housing. However, the batteries may be placed in the housing from its upper opening and enclosed by a cover of the housing, so that a battery cover may be eliminated. Alternatively, the power supply is a power cord to be electrically connected with a power source directly.

Preferably, the cover of the liquid dispensing device is formed with the housing integrally, e.g., by ultrasonic welding.

Preferably, the liquid dispensing device is further attached with a liquid source such as a container filled with liquid.

The liquid dispensing device may be used to dispense any suitable consumer products, for example personal care products or home care products. Preferably, the device is used to dispense a cleansing product, more preferably a cleansing product comprising cleansing surfactants. Preferably, the consumer product has a viscosity of at least 10 mPa·s, more preferably in the range 30 to 10000 mPa·s, even more preferably 50 to 5000, and most preferably 100 to 2000 mPa·s, when measured at 20 degrees C. at a relatively high shear rate of about 20 s⁻¹. Preferably, the liquid source is a container filled with the above-mentioned products.

### EXAMPLES

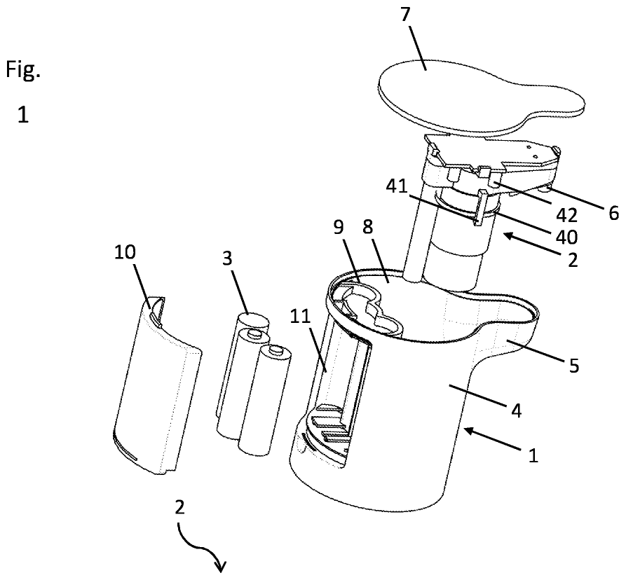

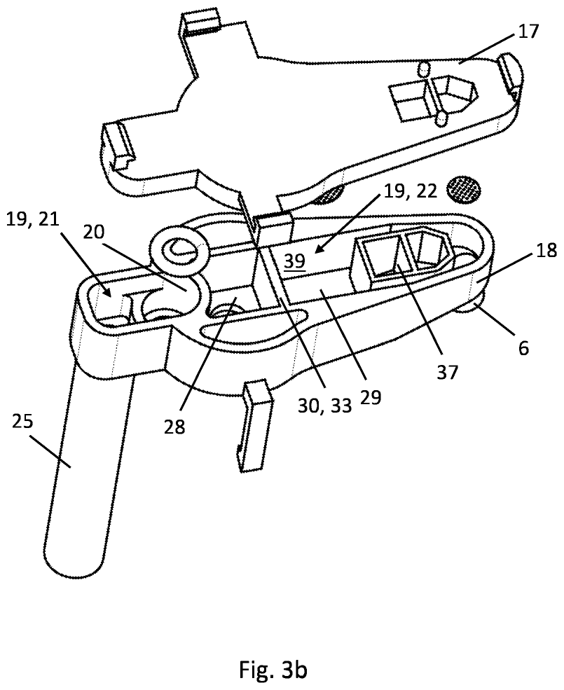

The following example is provided in FIGS. 1 to 6 to facilitate an understanding of the invention. The example is not intended to limit the scope of the claims.

FIG. 1 shows an overall configuration of the liquid dispensing device in an exploded perspective view. The liquid dispensing device is intended to be used with a container filled with liquid (not shown).

With reference to FIG. 1, the liquid dispensing device comprises a housing 1, a pump assembly 2 accommodated in the housing 1, and a power supply 3 to supply power to the pump assembly 2. The pump assembly 2 is configured to draw in liquid to mix with gas and then pump the gas-liquid mixture out.

The housing 1 comprises a main body 4 of a substantially cylindrical shape, a projection 5 projecting from the main body 4 for receiving a nozzle 6 of the pump assembly 2, and a cover 7 for closing the upper opening 8 of the main body 4. A shield 9 is provided in the housing 1 to prevent the power supply from liquid intrusion. The shield 9 is shaped to fix both the pump assembly 2 and the power supply 3 in the housing 1 by a simple insertion. As shown in FIG. 1, the shield 9 is shaped at both sides to have complementary contours with the pump assembly 2 and the power supply 3 respectively. The shield 9 is arranged in a longitudinal direction of the housing 1 to make the whole structure compact.

The power supply 3 comprises batteries. A battery cover 10 is arranged at a lateral opening 11 of the housing 1 to enclose the batteries in the housing 1. The batteries can be replaced with new ones after removal of the battery cover 10.

### Pump Assembly

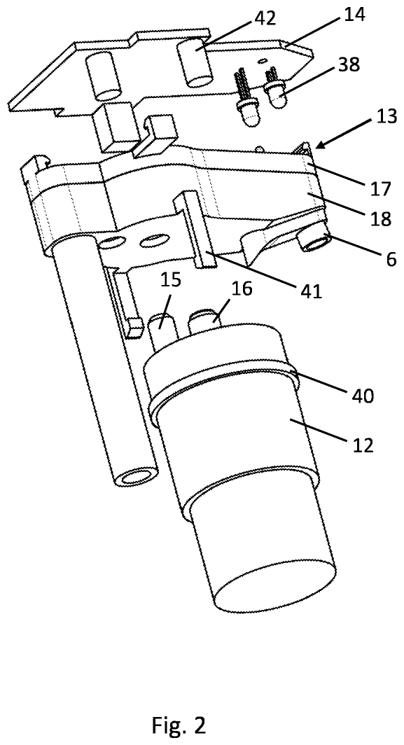

FIG. 2 shows the pump assembly 2 in an exploded perspective view. The pump assembly 2 is of three-in-one type. Specifically, the pump assembly 2 integrates a gas-liquid mixing pump 12, a flow path board 13 and a main control board 14 configured as PCB (Printed Circuit Board). The gas-liquid mixing pump 12 is in fluid communication with the flow path board 13 to receive the liquid therefrom and return the gas-liquid mixture thereto. The flow path board 13 is snap-fitted to the pump 12 by hooks 41 which are to be engaged with an annular flange 40 on the pump 12. The main control board 14 is snap-fitted to the flow path board 13 to control the operation of the pump 12. The pump assembly 2 in an assembled state is shown in FIG. 1. With conventional hose connections replaced with the flow path board 13, the present invention provides a much simpler structure which greatly reduces the risk of liquid and/or gas leakage. In addition, the integrated three-in-one pump assembly makes the assembling of the liquid dispensing device much quicker and easier.

### Gas-Liquid Mixing Pump

As can be seen from FIG. 2, the gas-liquid mixing pump 12 is provided with an inlet 15 for receiving liquid from the flow path board 13. After the liquid is mixed with gas in the pump 12, the gas-liquid mixture is returned to the flow path board 13 through an outlet 16 of pump 12. The inlet 15 and the outlet 16 are adjacent to each other and protrude from the pump 12 to a side of the flow path board 13 to achieve a compact structure.

### Flow Path Board

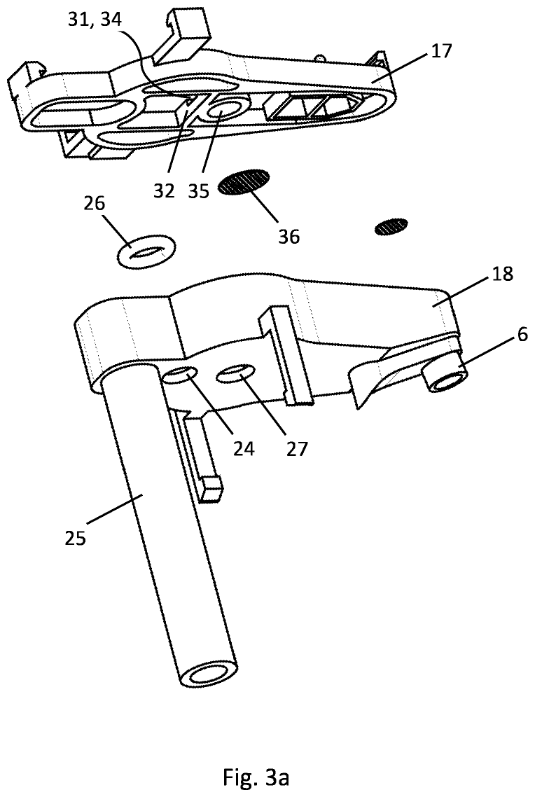

FIGS. 3a and 3b are exploded perspective views of the flow path board 13 as seen from below and above respectively. As shown in the figures, the flow path board 13 comprises an upper board 17 and a lower board 18 fitted to each other fluid-tightly to form a flow path therebetween. The flow path board 13 is intended to be connected with a container filled with liquid at its upstream to receive liquid therefrom. A nozzle 6 is provided at the downstream of the flow path board 13 to dispense the gas-liquid mixture. In operation, liquid is pumped from the container into the flow path board 13, and then drawn into the pump 12 to be mixed with gas and the resulted gas-liquid mixture is returned to the flow path board 13 to be dispensed via the nozzle 6.

With reference to FIG. 3b, the flow path board 13 defines a chamber 19 between the upper and lower boards 17, 18. The chamber 19 is divided by a partition wall 20 into a pre-mixing region 21 and a mixed region 22 which are separated from each other fluid-tightly. In the pre-mixing region 21, the liquid has just flowed from the container and has not been mixed with gas, while in the mixed region 22, the liquid has passed through the pump 12 and has been mixed with gas. Specifically, the pre-mixing region 21 is in fluid communication with the container to receive the liquid therefrom, and is in fluid communication with the inlet 15 of the pump 12 to deliver the liquid thereto; the mixed region 22 is in fluid communication with the outlet 16 of the pump 12 to receive the gas-liquid mixture therefrom, and is in fluid communication with the nozzle 6 to dispense the gas-liquid mixture.

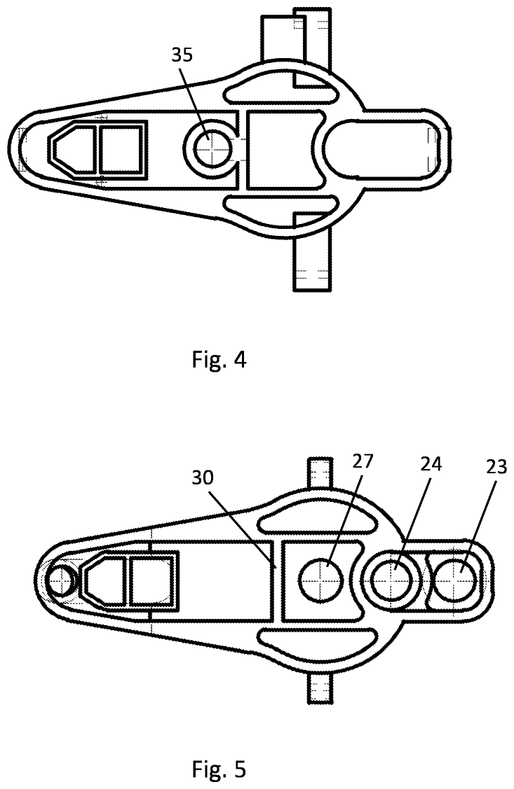

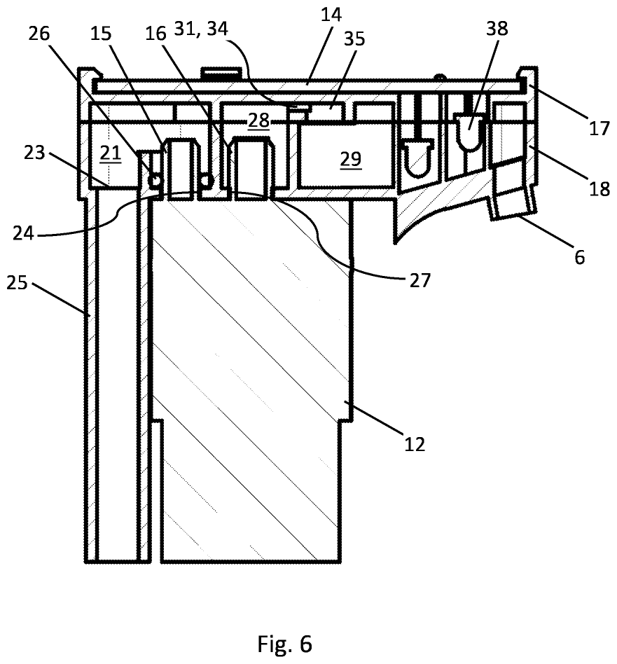

The lower board 18 is provided with an inlet 23 and an outlet 24 in communication with the pre-mixing region 21 as shown in FIGS. 5 and 6. A tube 25 is arranged at the inlet 23 to draw liquid from the container. The gas-liquid mixing pump 12 is connected with the lower board 18 at the outlet 24 to receive the liquid from the pre-mixing region 21. That is to say, the inlet 15 of the pump 12 is connected with the outlet 24 of the lower board 18. A sealing member 26 in the form of an O-ring (as shown in FIG. 3a) is arranged at the outlet 24 to prevent liquid leakage.

The lower board 18 is further provided with an inlet 27 in communication with the mixed region 22 as shown in FIGS. 5 and 6. The inlet 27 of the lower board 18 is interference fitted with the outlet 16 of the pump 12 to receive the gas-liquid mixture therefrom. The gas-liquid mixture in the mixed region 22 flows toward the nozzle 6 to be dispensed.

When the gas-liquid mixture is returned to the lower board 18 from the pump 12, it is inclined to generate turbulence at the inlet 27 of the lower board 18. To provide a stable and smooth flow to users, as shown in FIG. 3b, the mixed region 22 is further divided into a buffer zone 28 and a discharging zone 29 by a barrier 30 which is positioned between the inlet 27 and the nozzle 6. With reference to FIGS. 3a and 6, a passage 31 is configured as a gap 34 formed between the barrier 30 and the upper board 17 to communicate the buffer zone 28 with the discharging zone 29.

As shown in FIGS. 3a, 3b and 6, the barrier 30 includes an upper segment 32 located at the upper board 17 and a lower segment 33 located at the lower board 18. When the upper and lower boards 17, 18 are fitted to each other, the upper and lower segments 32, 33 align and contact with each other to form the barrier 30 with the gap 34 formed between an upper end of the upper segment 32 and an inner wall surface of the upper board 17.

To further stabilize the gas-liquid mixture flow at the nozzle 6 in the discharging zone 29, an additional port 35 is provided to the passage 31 and is configured to direct the gas-liquid mixture downward to the discharging zone 29 rather than toward the nozzle 6 directly. With such a port, the gas-liquid mixture will flow into the discharging zone 29 in a direction deviating from the nozzle 6 without causing a disturbance at the nozzle 6 directly.

To achieve a better foaming effect, a foam booster 36 is arranged in the passage 31. The foam booster 36 is made of nylon and has a porous structure. The foam booster 36 comprises two nylon layers which are stacked on each other and fixed in the passage 31, and more specifically fixed in the port 35. The foam booster 36 is made of nylon, which greatly reduces the risk of corrosion.

In the mixed region 22, there is provided a separate cavity 37 near the nozzle 6 of the flow path board 13 to place a sensor 38 (as shown in FIG. 2) therein for sensing approaching of an object. The cavity 37 is spaced from an inner wall 39 of the flow path board 13 so that the gas-liquid mixture can bypass the cavity 37 to arrive at the nozzle 6. The cavity 37 is opened at a side of the main control board 14 to receive the sensor 38 arranged thereon. Two sensors 38 as shown in the figures are arranged to be received in two corresponding cavities 37. The sensor 38 is a contactless distance sensor.

The nozzle 6 is also arranged with a foam booster to enhance the foaming effect. The foam booster is configured similarly as that arranged in the passage 31 in the flow path board 13.

### Main Control Board

Returning to FIG. 2, the main control board 14 is fitted to the flow path board 13, more specifically to the upper board 17. The main control board 14 is powered by the power supply 3 and controls the operation of the pump assembly 2. The sensor 38 is arranged on the main control board 14 as shown in FIG. 2 is inserted into the cavity 37 of the flow path board 13. The main control board 14 is snap-fitted to the flow path board 13 so that no screws are required and the assembly is simplified. To help fixing the upper board 17 to the lower board 18, three protrusions 42 shown in FIG. 2 are depending from the main control board 14 to hold opposite sides of the upper board 17 and the lower board 18 as shown in FIG. 1.

The liquid dispensing device according to the example of the present invention is operated as follows.

The device is attached to a container filled with liquid and powered on before use. When the sensor 38 arranged near the nozzle 6 of the flow path board 13 senses approaching of hands of a user, the pump 12 is initiated automatically so that the liquid is drawn from the container into the device via the tube 25 arranged at one end of the flow path board 13. The liquid is first drawn into the pre-mixing region 21 of the flow path board 13, and then into the pump 12 through the outlet 24 of the board 13 and the inlet 15 of the pump 12. After the liquid is mixed with gas in the pump 12, it is pumped back to the mixed region 22 of the board 13 through the outlet 16 of the pump 12 and the inlet 27 of the board 13, and then dispensed through the nozzle 6. Being triggered by the contactless sensor, the liquid dispensing device operates automatically.

The present invention provides a pump assembly with a more integrated structure, i.e., the main control board 14, the flow path board 13 and the gas-liquid mixing pump 12 are integrated into one assembly, which simplifies assembling and maintenance thereof. The main control board 14 is snap-fitted to the flow path board 13 and the flow path board 13 is snap-fitted to the pump 12, which makes assembling of these components much easier and quicker.

The gas-liquid mixing pump 12 in the pump assembly of the present invention is connected with the flow path board 13 directly without any hose connections, which makes the device more compact and easier to assemble and repair. Additionally, the risk of leakage that may be incurred by the conventional silicone hose connections is greatly reduced which improves durability of the pump assembly and the liquid dispensing device.

1. An integrated pump assembly for a liquid dispensing device comprising:
a flow path board formed with a flow path therein to receive liquid from a liquid source and dispense a gas-liquid mixture;
a gas-liquid mixing pump connected with the flow path board to receive the liquid therefrom and return the gas-liquid mixture thereto; and
a main control board for controlling the operation of the gas-liquid mixing pump;
wherein the flow path board comprises an upper board and a lower board fitted to each other with the flow path formed therebetween.

2. The pump assembly according to claim 1 wherein the flow path board is provided with a pre-mixing region and a mixed region located at an upstream and a downstream of the gas-liquid mixing pump respectively.

3. The pump assembly according to claim 2 wherein the mixed region is provided with a buffer zone and a discharging zone communicated with each other.

4. The pump assembly according to claim 1, wherein a tube is arranged to communicate the flow path board with the liquid source.

5. The pump assembly according to claim 1 wherein the flow path board is provided with a foam booster to boost foam.

6. The pump assembly according to claim 5, wherein the foam booster is located at a nozzle of the flow path board and/or in a passage located at a side of the nozzle.

7. The pump assembly according to claim 5, wherein the foam booster is made of plastic.

8. The pump assembly according to claim 6 wherein the passage is provided with a port which directs the gas-liquid mixture into the discharging zone.

9. The pump assembly according to claim 1 wherein the main control board has a sensor mounted thereon, and the sensor is inserted into the flow path board for sensing approaching of an object.

10. The pump assembly according to claim 9 wherein a separate cavity is formed in the flow path board to receive the sensor, preferably the cavity is spaced from opposite inner wall surfaces of the flow path board to establish bypass paths for the gas-liquid mixture to flow through to the nozzle.

11. The pump assembly according to claim 1 wherein the flow path board is snap-fitted to the gas-liquid mixing pump, and/or the main control board is snap-fitted to the flow path board.

12. The pump assembly according to claim 1 wherein the gas-liquid mixing pump is connected with the flow path board directly without any hose connections.

13. A liquid dispensing device comprising a housing, a pump assembly according to claim 1, and a power supply to supply power to the pump assembly.

14. The liquid dispensing device according to claim 13, wherein the device further attached with a liquid source.

15. The liquid dispensing device according to claim 14, wherein the liquid source is a container filled with liquid.

16. The liquid dispensing device of claim 4, wherein the tube is formed with the flow path board integrally.

17. The liquid dispensing device of claim 5, wherein the foam booster has a porous structure.

18. The liquid dispensing device of claim 7, wherein the foam booster is made of nylon.

19. The liquid dispensing device of claim 9, wherein the sensor is a contactless distance sensor and/or an infrared sensor.
